(19) United States
(12) Patent Application Publication
(10) Pub. No.: US 2003/0233121 A1
(43) Pub. Date: Dec. 18, 2003

(54) Baby teething ring

(76) Inventor: Catherine B. Keller, Cape Coral, FL (US)

Correspondence Address: Catherine B. Keller, 1421 SW 28th Street, Cape Coral, FL, 33914, US

(21) Appl. No.: 10/172,659

(22) Filed: Jun. 17, 2002

(51) Int. Cl. A61J 17/00

(52) U.S. Cl. 606/235

(57) ABSTRACT

The invention is directed to a teething ring combination. The teething ring is an oval shape of differing cross sections such as I shaped or round. The pacifier section is attached to a straight section of the oval ring. The teething ring combination consists of a loop of fabric such as terry cloth. The teething ring combination section can be constructed of a doubled backed piece of fabric and is slipped over an opening in a straight section of the oval ring. The fabric of the terry cloth loop fabric can also be stitched around the long section of the oval ring.

### CROSS REFERENCE TO RELATED APPLICATIONS

(None)

### STATEMENT REGARDING FED SPONSORED R$D

(None)

### BACKGROUND OF THE INVENTION

The invention involves a baby teething ring. Such teething rings are well known and they are manufactured in all forms and shapes. Most of them are shaped in a bulbous soft plastic rubber like material which are used by the infant or baby in their full mouth. However when a baby starts teething, any known pacifiers are no longer adequate because the emerging teeth will chew such a structure to pieces which is most undesirable. It is also known that when babies are teething, their gums are itching which renders the baby quite unsettled. The normal teething rings or other structures are no help to alleviate these symptoms.

### BRIEF SUMMARY OF THE INVENTION

In view of all of the above, it would be highly desirable to construct a baby teething ring that accomplishes both to act as a teething instrument as well as to act as a massager for the gums of the baby. To this end the teething ring consists of a ring of semi-rigid material to which is attached a material that will greatly enhance the massaging of the baby's gums.

### BRIEF DESCRIPTION OF THE DRAWINGS

FIG. 1 illustrates a baby teething ring to which is attached a gum massaging material.

FIG. 2 shows a different shape of a teething ring.

### DETAILED DESCRIPTION OF THE INVENTION

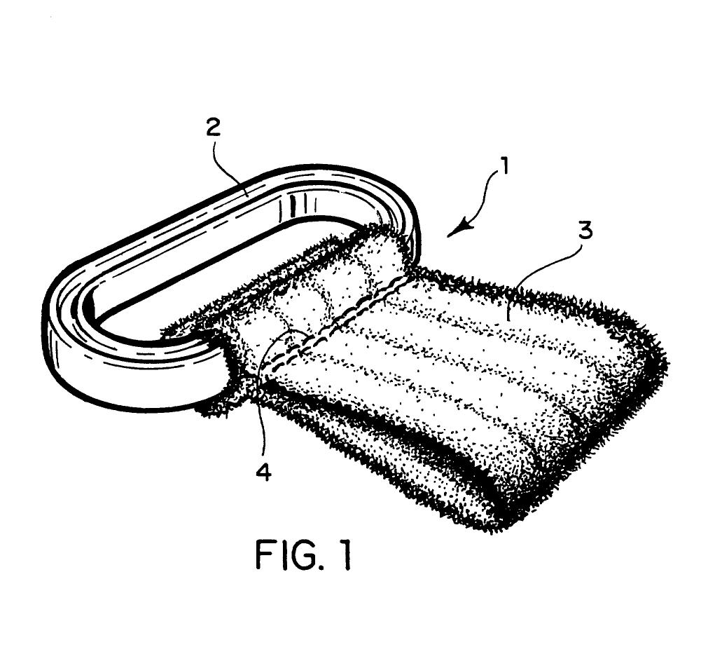

FIG. 1 shows the overall teething ring at 1 including a teething ring itself at 2 and a material 3 attached thereto. The teething ring 2 is shown in an oval shape while other shapes may also be used. The oval shape is preferred because this type of shape cannot enter the full mouth of the bay which is highly desirable for safety reasons. A round shape could enter the baby's mouth and could cause suffocation. To the long side of the oval, a material 3 is attached. The material should consist of a loop material such as terry cloth. For best results, the loops are attached to the surface of the material such as by knitting or by weaving. Experiments have shown that the loops of the material are very beneficial in soothing the gums as the teeth are about to emerge from the gums and, of course, thereafter. At other times the teething ring will be most beneficial prior to the teeth breaking through the gums. In FIG. 1, the cross section of the ring shows a double I outline. This shape presents edges which some babies seem to prefer, especially when they get along in age. The terry cloth of FIG. 1 is doubled back upon itself to give it some bulk when it is fastened to the ring 2. The fastening is accomplished by a seam 4 which attaches the terry cloth to the ring 2 in order to leave an elongated patch of fabric 3 to be used by the baby.

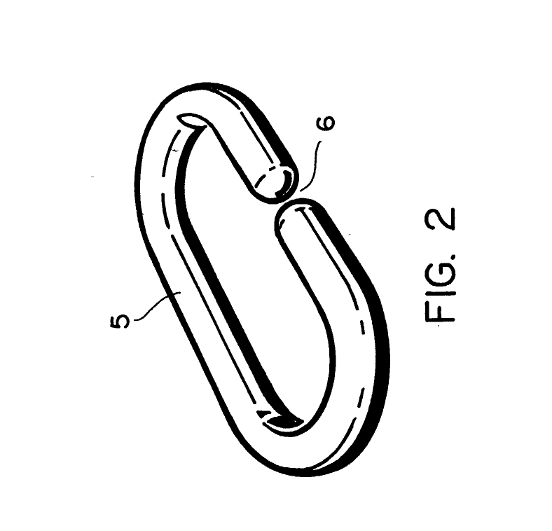

The stitching 4 can by done after the terry cloth has been draped over the ring 2 or can be stitched first and then slipped over the ring as is shown in FIG. 2.

In FIG. 2 there is shown a teething ring 5 having a round cross section and having an opening 6 therein which is instrumental when the loop on the terry cloth is sewn first and then is slipped over the opening 6. Once the tunnel which is sewn by the stitching 4 is slipped over the ring of FIG. 2, the opening 6 in the ring 5 will be concealed so that he ring appears in the shape as is shown in FIG. 1. It is preferred that the terry cloth material be attached to the teething ring 2 or 5 in squared configuration because of ease of construction.

What I claim is:

1. A teething ring combination comprising an oval teething ring adapted to be used by an infant for the purpose of teething, an attachment attached to said teething ring for massaging the gums of an infant, said attachment including a piece of fabric having loops thereon.

2. The teething ring combination of claim 1 wherein said piece of fabric is doubled back on itself forming a substantial squared off front.

3. The teething ring combination of claim 1 wherein said piece of fabric having said loops thereon is stitched into said doubled back loop close to said teething ring.

4. The teething ring combination of claim 1 wherein said teething ring has a cross section of an I.

5. The teething ring combination of claim 1 wherein said teething ring has a cross section of a circle.

6. The teething ring combination of claim 1 wherein said teething ring has an opening in its long side.
